(19) United States
(12) Patent Application Publication
(10) Pub. No.: US 2004/0046899 A1
(43) Pub. Date: Mar. 11, 2004

(54) Vehicle interior projection entertainment system

(76) Inventor: Craig Eugene Bonnett, Royal Oak, MI (US)

Correspondence Address: LAURA C. HARGITT, General Motors Corporation, Legal Staff, Mail Code 482-C23-B21, P.O. Box 300, Detroit, MI, 48265-3000, US

(21) Appl. No.: 10/235,365

(22) Filed: Sep. 5, 2002

(51) Int. Cl. H04N 5/64; H04N 9/47

(52) U.S. Cl. 348/744

(57) ABSTRACT

A vehicular entertainment system comprising a projector and a semi-transparent screen in a vehicle is disclosed. The projector projects an image in the vehicle and the semi-transparent screen is deployable from an interior trim component for receiving the projected image in the vehicle.

### BACKGROUND OF THE INVENTION

1. Field of the Invention

The present invention relates to vehicular interiors, and in particular to a projection entertainment system incorporated with vehicular interior structures.

2. Background of the Invention

Typically, vehicular entertainment systems for viewing television broadcasts from an antenna, digital video discs (DVDs), or the like, comprise a liquid crystal display (LCD) screen or other hard-wired screen devices. The hard-wired screens are usually mounted to the headliner and are limited in viewing area so as not to obstruct the driver's sight-line in the rear-view mirror. As a result, passengers in the rear portion of the vehicle are limited to enjoying the picture on a small viewing area.

Even further, if the hard-wired screens are installed remote from the assembly line in the after market, the after market installation usually results in the removal and drilling of holes in the headliner so that the hard-wired screen may be installed. Such alterations may reduce the value of the vehicle if the owner wishes to remove the hard-wired screen prior to selling the vehicle.

Thus, a need exists for a vehicular interior entertainment system that increases the viewing area of the screen while not obstructing the view of the driver. There also is a need for a vehicular entertainment system that may be installed on the assembly line or modularly installed in the vehicle interior trim prior to when the vehicle is assembled on the assembly line in order to limit the after market installation damage to the vehicle interior.

### SUMMARY OF THE INVENTION

In a first embodiment of the invention, a vehicular entertainment system is described. The vehicular entertainment system comprises a projector and a semi-transparent screen. The projector projects an image in a vehicle. The semi-transparent screen is deployable from an interior trim component for receiving the projected image in the vehicle.

Another embodiment of the invention is a vehicular entertainment system deployable from a headliner comprising a projector and a semi-transparent screen including a screen stabilizer. The projector is deployable from the headliner. The semi-transparent screen is defined by a viewing surface having a length and a width. The semi-transparent screen is deployable from the headliner and is adapted to receive a projected image projected from the projector. The screen stabilizing system stabilizes the semi-transparent screen.

Another embodiment of the invention is a vehicular entertainment system deployable from a headliner and a base pan. The vehicular entertainment system comprises a projector and a semi-transparent screen including a screen stabilizer. The projector is deployable from the base pan. The semi-transparent screen is defined by a viewing surface having a length and a width. The semi-transparent screen is deployable from the headliner and is adapted to receive an image projected from the projector. The screen stabilizing system stabilizes the semi-transparent screen.

Another embodiment of the invention is a vehicular entertainment system, deployable from a headliner and a rear seat including a pivotable armrest near the trunk. The vehicular entertainment system comprises a projector and a semi-transparent screen including a screen stabilizer. The projector is operable when the armrest is pivotably deployed. The semi-transparent screen is defined by a viewing surface having a length and a width. The projector is deployable from the headliner and is adapted to receive an image projected from the projector. The screen stabilizing system stabilizes the semi-transparent screen.

Another embodiment of the invention is a vehicular entertainment system comprising means for projecting an image in a vehicle and means for receiving and viewing the projected image in the vehicle.

Various additional aspects and advantages of this invention will become apparent to those skilled in the art from the following detailed description of the preferred embodiment, when read in light of the accompanying drawings.

### BRIEF DESCRIPTION OF THE DRAWING

FIG. 1 is an environmental view of a vehicle interior including the projection entertainment system (PES);

FIG. 2 is a perspective view of an installation arrangement for a screen of the PES according to one embodiment of the invention;

FIG. 3 is a magnified view of a component of the installation arrangement of the PES according to FIG. 2;

FIG. 4A is a perspective view of a step of installing the screen of the PES according to FIG. 2;

FIG. 4B is a perspective view of a step of manually deploying the screen of the PES according to FIG. 2;

FIG. 4C is a perspective view of a step for securing the screen of the PES of FIG. 4B according to one embodiment of the invention;

FIG. 4D is a perspective view of a step for securing the screen of the PES of FIG. 4B according to another embodiment of the invention;

FIG. 5 is a perspective view of an installation arrangement of the screen of the PES according to another embodiment of the invention;

FIG. 6 is a cross-sectional view of an installation arrangement of the screen of the PES according to another embodiment of the invention;

FIG. 7 is flow chart of an electrical system for deploying and stowing the screen of the PES of FIGS. 2, 5 and 6;

FIG. 8A is a partial phantom view of the side of a mini-van illustrating a location of a projector according to one embodiment of the invention;

FIG. 8B is a partial phantom view of the side of a mini-van illustrating a location of a projector according to another embodiment of the invention;

FIG. 9A is a perspective view of the installation arrangement of the projector of FIG. 8B according to one embodiment of the invention;

FIG. 9B is a cross-sectional view of the installation arrangement of the projector according to FIG. 9A;

FIG. 10 is a partial phantom view of the side of a sedan illustrating a position of a projector according to another embodiment of the invention;

FIG. 11A is a perspective view of the installation arrangement of the projector of FIG. 10 in a stowed position according to one embodiment of the invention; and

FIG. 11B is a perspective view of the installation arrangement of the projector of FIG. 11A in a deployed position according to one embodiment of the invention.

### DESCRIPTION OF THE PREFERRED EMBODIMENTS

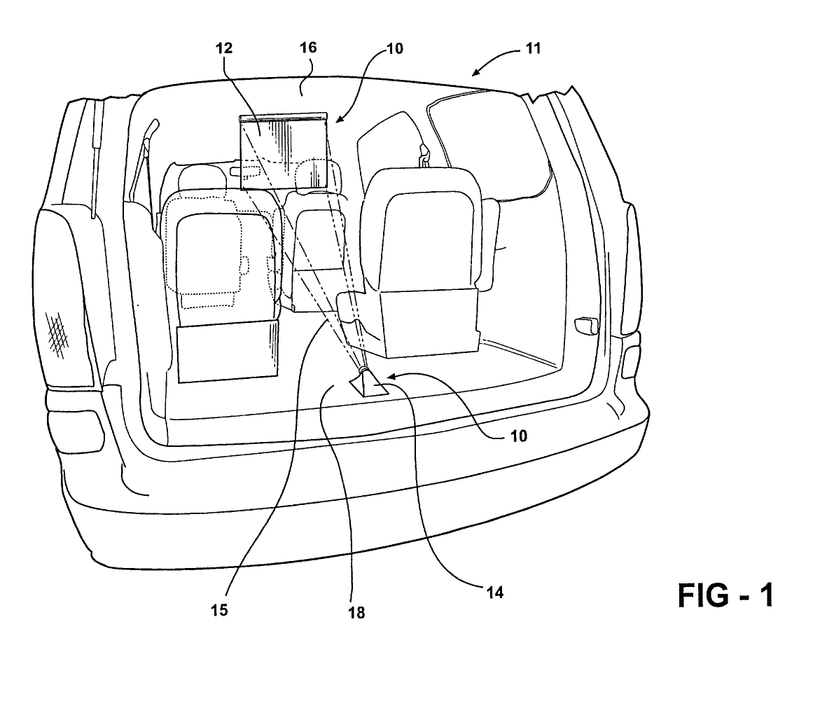

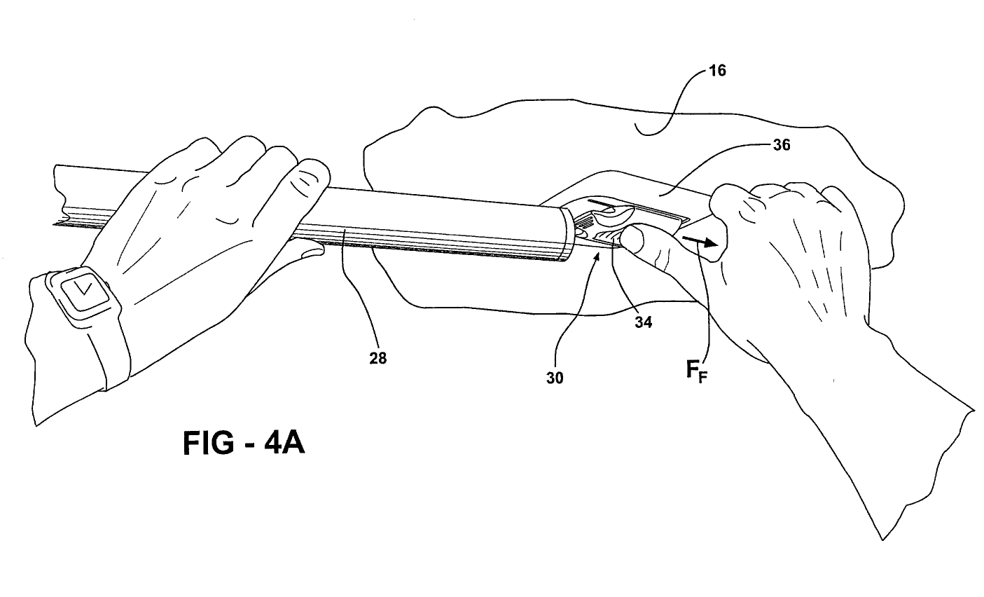

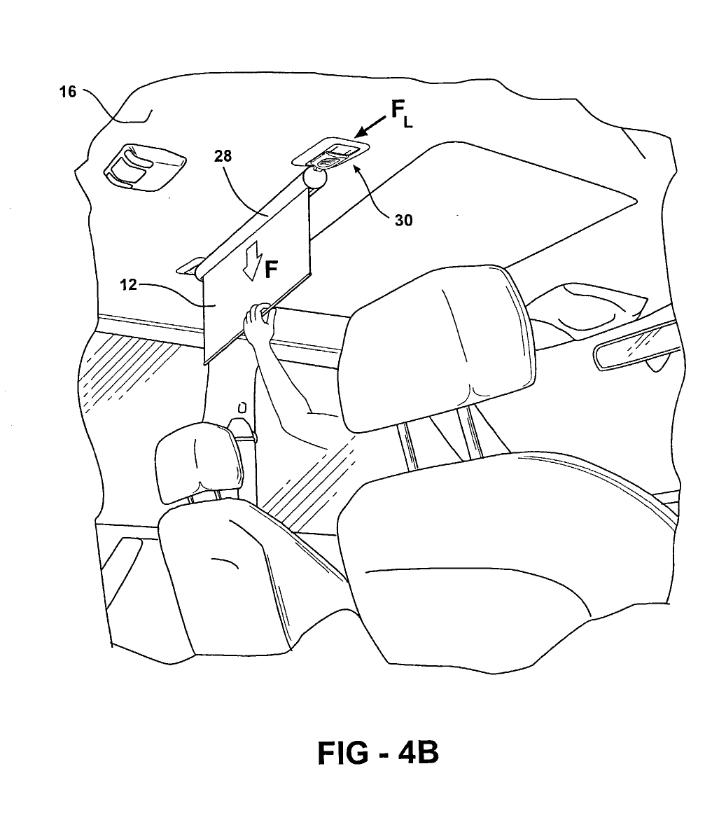

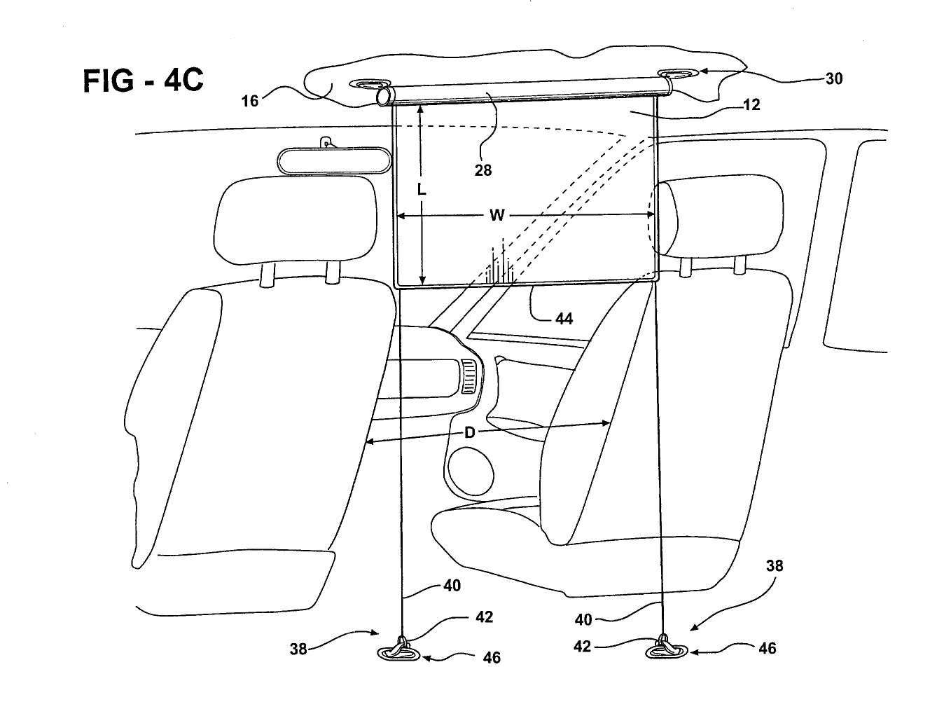

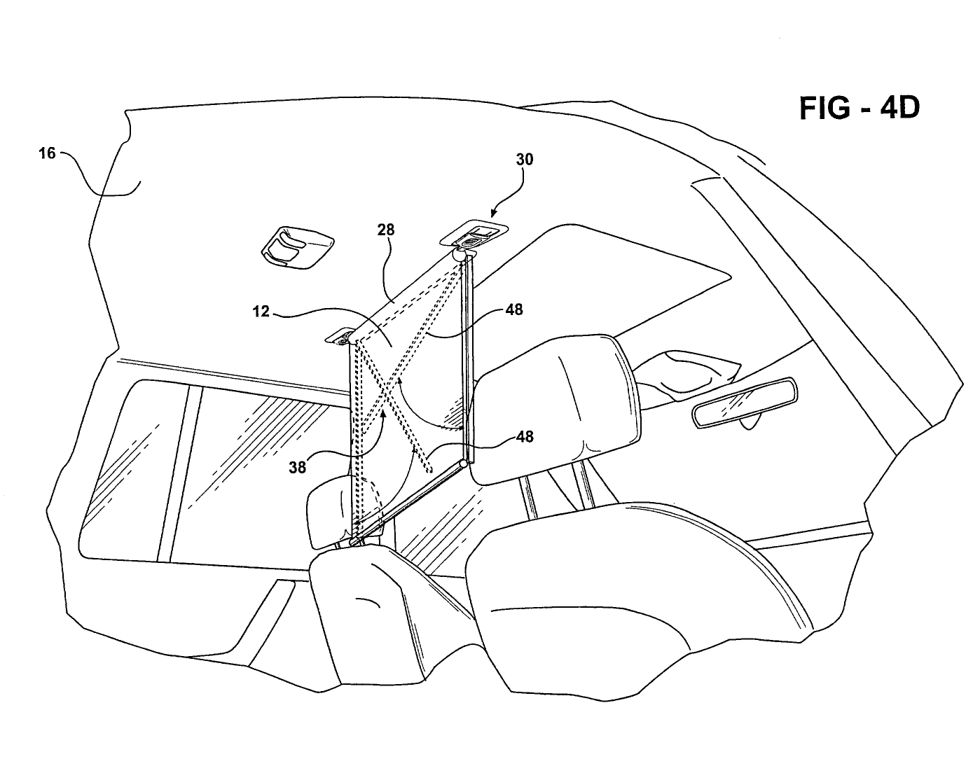

A vehicular projection entertainment system (PES) 10 comprises means for receiving and viewing a projected image and means for projecting an image. The means for receiving and viewing a projected image comprises at least a screen 12 (FIGS. 1, 4B-6, 8A-8B, 10-11B). The means for projecting an image comprises at least a projector 14 (FIGS. 1 and 8A-11B). The screen 12 and projector 14 may be deployable from a stowed to an in-use position from an interior trim component of a vehicle. The screen 12 and the projector 14 may be deployed manually by hand (FIG. 4B) or by actuating electrical circuitry with an actuating device (FIG. 7).

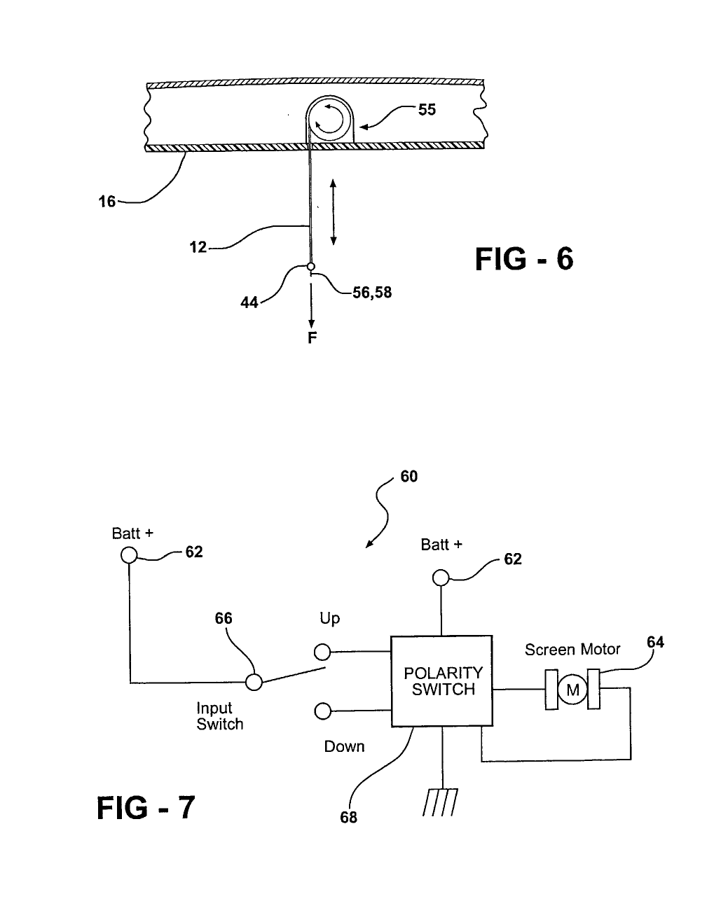

The screen 12 may be located on the exterior surface of the interior trim component, for example, a headliner 16 (FIGS. 1-5), B-pillar, rear portion of a front seat, or the like. Alternatively, the screen 12 may be modularly incorporated into the interior structure of the interior trim component, for example the headliner 16 (FIG. 6), B-pillar, rear portion of a front seat, or the like. When in the stowed position, the screen 12 may be hidden from view of the vehicle passengers.

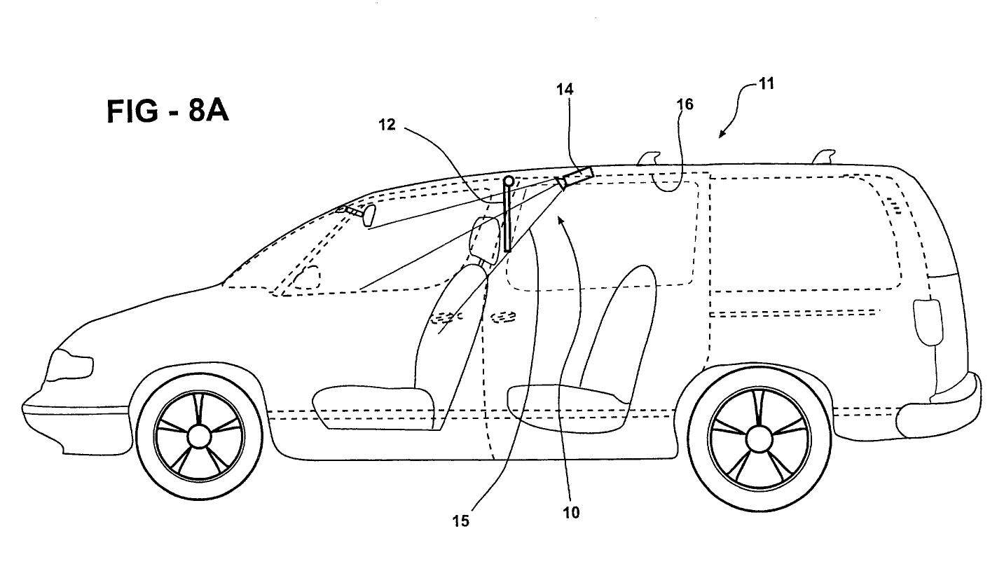

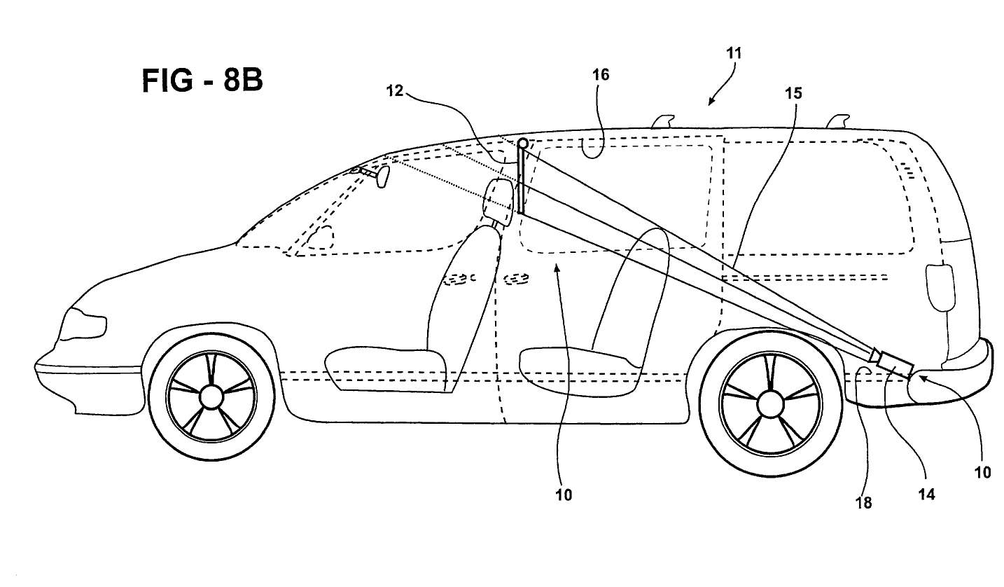

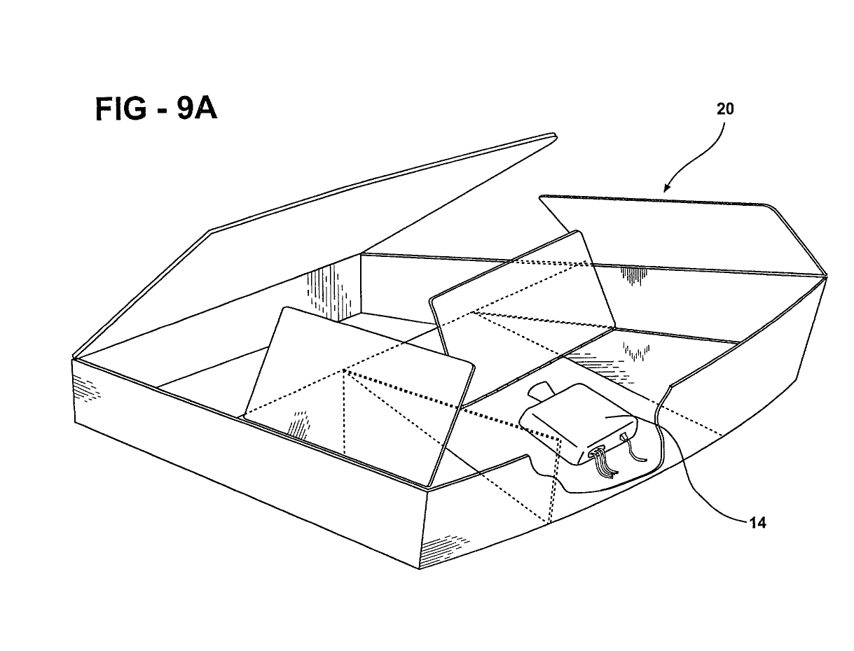

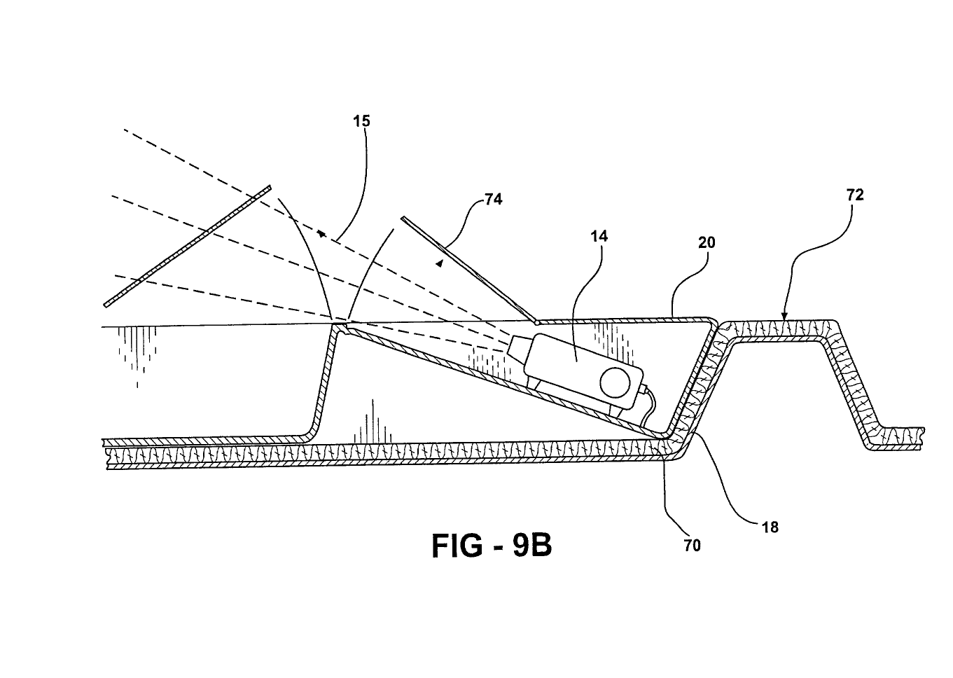

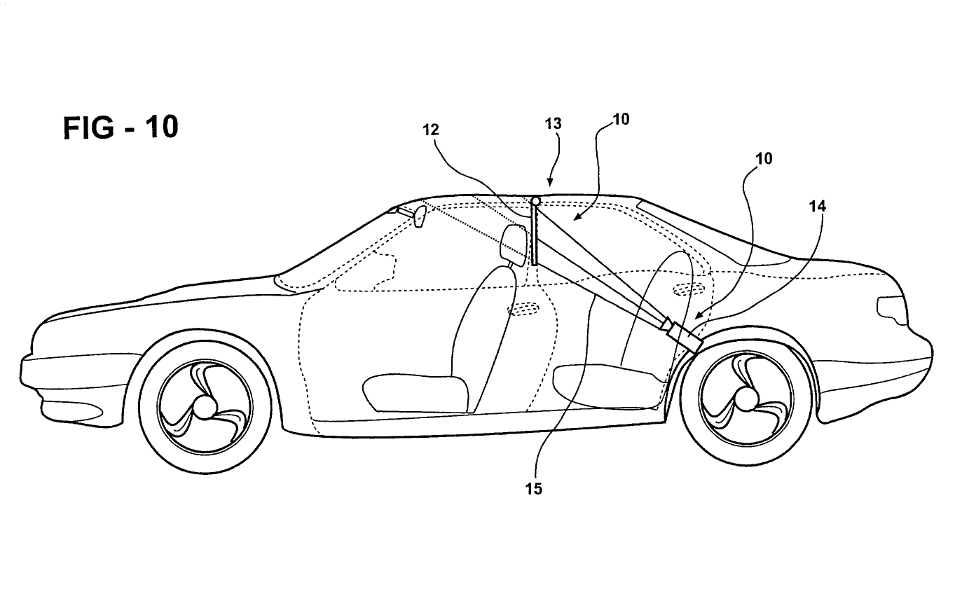

The projector 14 may also be located on the exterior surface of the interior trim component, for example, the headliner 16, B-pillar, or the like. The projector 14 may alternatively be modularly incorporated into the interior trim component, for example, the headliner 16, B-pillar, or the like (FIG. 8A). Alternatively, the projector 14 may be located about the exterior surface or within the interior structure of a base pan 18 (FIGS. 1, 8B). Even further, the projector 14 may also be located in a structural member 20 located about an exterior surface of the base pan 18 (FIGS. 9A-9B). Yet even further, the projector 14 may be located in a structural member, for example, an armrest 22; alternatively, the projector 14 may project an image through an opening 24 of a rear passenger seat 26 (FIGS. 10- 11B). When in the stowed position, the projector 14 may be protected and hidden from view of the vehicle passengers.

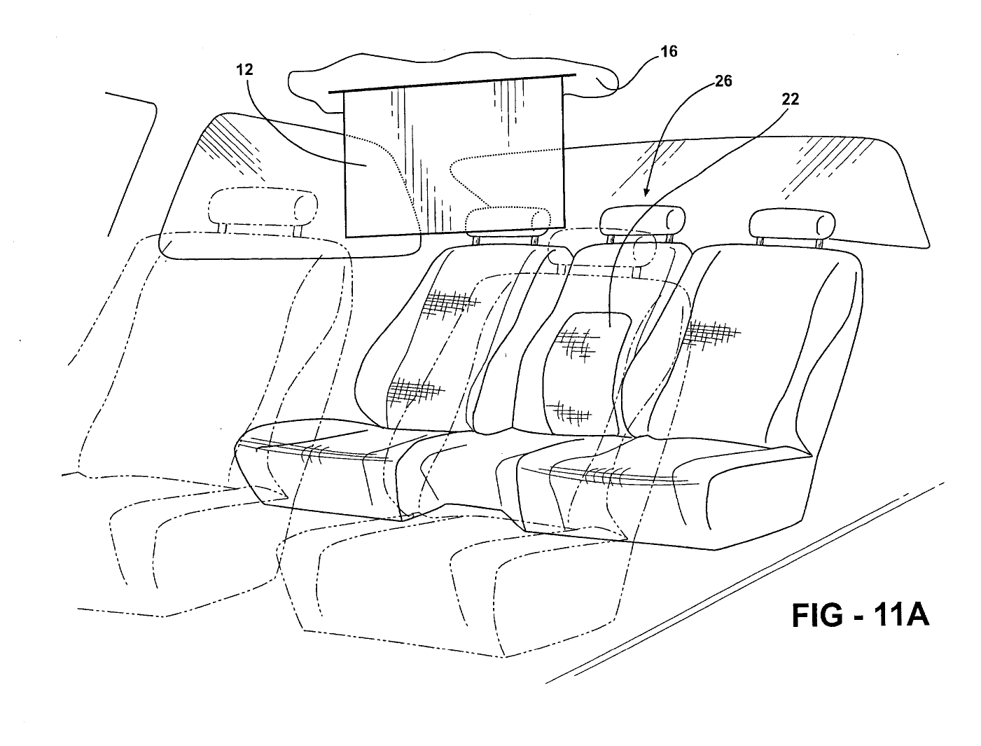

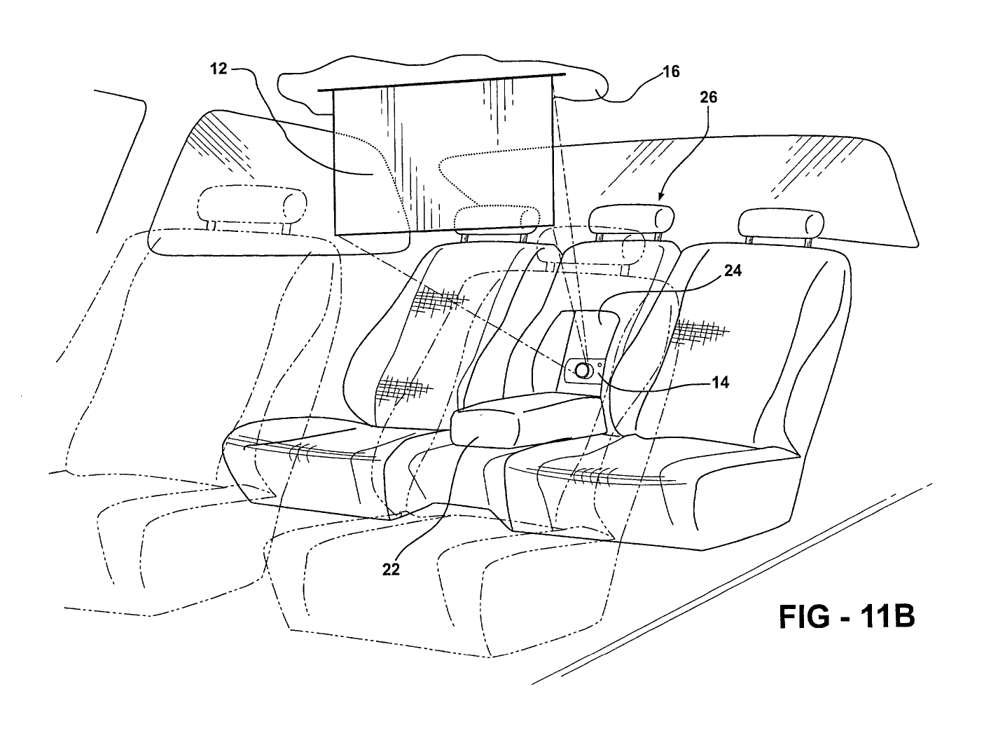

Referring now to FIG. 1, the screen 12 and projector 14 are shown located in the interior of a mini-van 11 (FIGS. 1, and 8A-9B). Alternatively, the screen 12 and the projector 14 may be similarly located in a sedan 13 (FIGS. 10-11B). Although not shown, the PES 10 may also be deployable from within any vehicle such as a bus, train, or the like. The screen 12 and projector 14 are at least two components that cooperate in the PES 10 for passengers seated in the rear portion of the vehicle. The projector 14 may project images from a plurality of entertainment sources including television broadcasts from an antenna, digital video discs (DVDs), video tapes, still image slides, or the like. The projector 14 may be any projector that is applicable for the various entertainment sources listed above. Although not shown in detail in the following drawings, all wiring is assumed to be incorporated into or behind the vehicle interior's trimmed surfaces.

The screen 12 is a flexible, light-weight material comprising a plurality of micro-perforations that renders the screen 12 as a semi-transparent material. The screen 12 may have a viewing area defined by any desirable width, W, and length, L (FIG. 4C). Because the screen 12 is semi-transparent, the driver's sight-line in the rear-view mirror is not fully hindered when the screen 12 is deployed. As a result of the semi-transparent qualities of the screen 12, the viewing surface of the screen 12 may be maximized, thereby creating a “big screen” effect for passengers seated in the rear area of the vehicle and maintaining the driver's rear-viewing through the rearview mirror. A similar screen material is described in detail in U.S. Pat No. 4,673,609, which is entitled “Unidirectional Panel.” The screen material is commercially available from 3M, and is sold under the trade-name of Scotchcal.

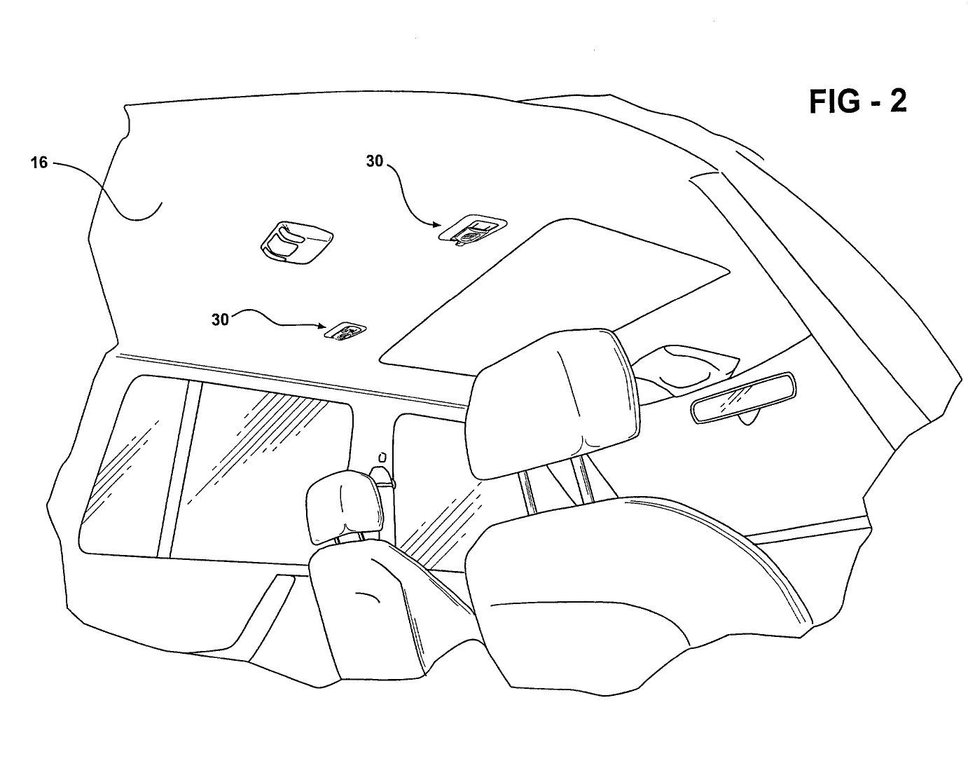

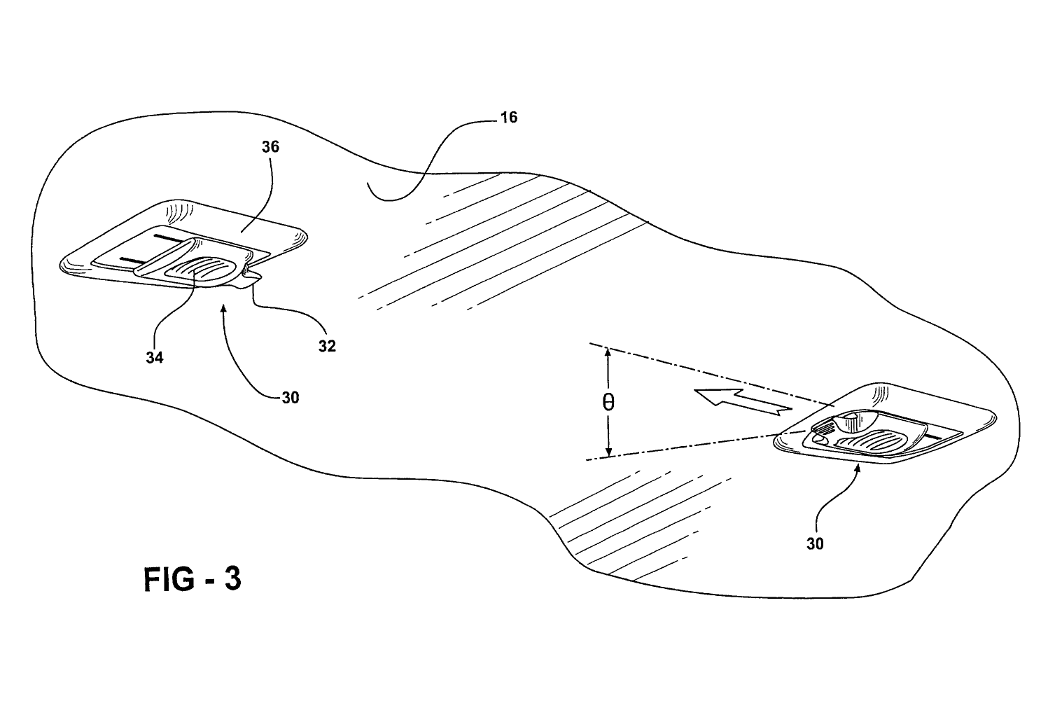

According to one embodiment of the invention, as seen in FIGS. 2-4A, an installation arrangement for the screen 12 of the PES 10 may be located on the outer surface of an interior trim component, such as the headliner 16. For purposes of illustration, an example comprising the headliner 16 is shown in the following embodiments. However, it is contemplated that the screen 12 may be deployed from other interior trim components such as a B-pillar, rear portion of a front seat, or the like. The screen 12 may be rolled on a tube 28 (FIGS. 4A-4D) and cooperates with a pair of spring-loaded clips 30 (FIGS. 2-4D). More specifically, the tube 28 may be a ‘pull-pull’ tube 28 for mechanically stowing and deploying the screen 12. The mechanics for the ‘pull-pull’ tube 28 is similar to the mechanics, for a ‘pull-pull’-type window shade. Referring to FIG. 3, each spring-loaded clip 30 includes a lip portion 32, frictional ribs 34, and a base 36 for slideable movement of the clip 30.

Referring to FIG. 4A, the screen 12, which is stowed and rolled in the tube 28, may be affixed to the spring loaded clips 30 by manually pushing each clip 30 in opposite directions about the frictional ribs 34. Each clip 30 is pushed with a minimal amount of force by one's fingers, F_{F}, which overcomes a lateral force F_{L} (FIG. 4B) of the springs, in order to slide the clips 30 outward on the base portions 36. The ends of the storage tube 28 may be mated with the lip portions 32 of the spring-loaded clips 30 and locked into place by ceasing the minimal outward finger force, F_{F}, on the spring-loaded clips 30 applied by one's fingers.

As seen in FIG. 4B, once each end of the tube 28 is located about the lip portions 32, the screen 12 may be unrolled by hand. In order to prevent damage to the screen 12, storage tube 28, or dislocation of the base portions 36 of the spring-loaded clips 30 from the headliner 16, each lip portion 32 may be designed with a tapered surface at an angle, θ, approximately equivalent to 45° (FIG. 3). The angle, θ, permits the storage tube 28 to be dislocated from the spring clips 30. The dislocation may occur in a situation when a force greater than the downward force, F (FIG. 4B), is applied to the screen 12 that is greater than the lateral spring force F_{L} acting on each end of the tube 28. Thus, the tapered surface at an angle, θ, protects the screen 12 from damage when it is undesirably pulled on.

Once the vehicle is in motion, the lightweight screen 12, upon full deployment, is apt to sway to and fro from its installed position. Referring to FIG. 4C, in order to overcome the potential of the screen 12 swaying to and fro, a screen stabilizing system 38 including tethers 40, with locating hooks 42, may extend from the bottom of the screen 12 at a deployment bar 44. Each hook 42 may anchor to a fixed structure 46 located on the lower trim of the front bucket seats, second row seating, base pan area, or the like of the vehicle. Referring to FIG. 4D, an alternate embodiment of the screen stabilizing system 38 may include a pair of rods 48, which may be transparent to provide the driver with a less obstructed rear view, that may hingedly deploy from the storage tube 28.

Although not shown, a second pair of rods, which may also be transparent, may hingedly deploy from the opposite side of the storage tube 28 in order to ‘sandwich’ each end of the screen 12. If desired, the tethers 40 and plastic rods 48 may be used either singularly, or in combination with each other. Alternatively, the screen stabilizing systems 38 may be obviated by designing the screen 12 to have a larger width, W, than the distance, D (FIG. 4C), between the front two bucket seats. In this particular embodiment, the screen 12 may be prevented from entering the driver's area by abutting the back portion of the front bucket seats.

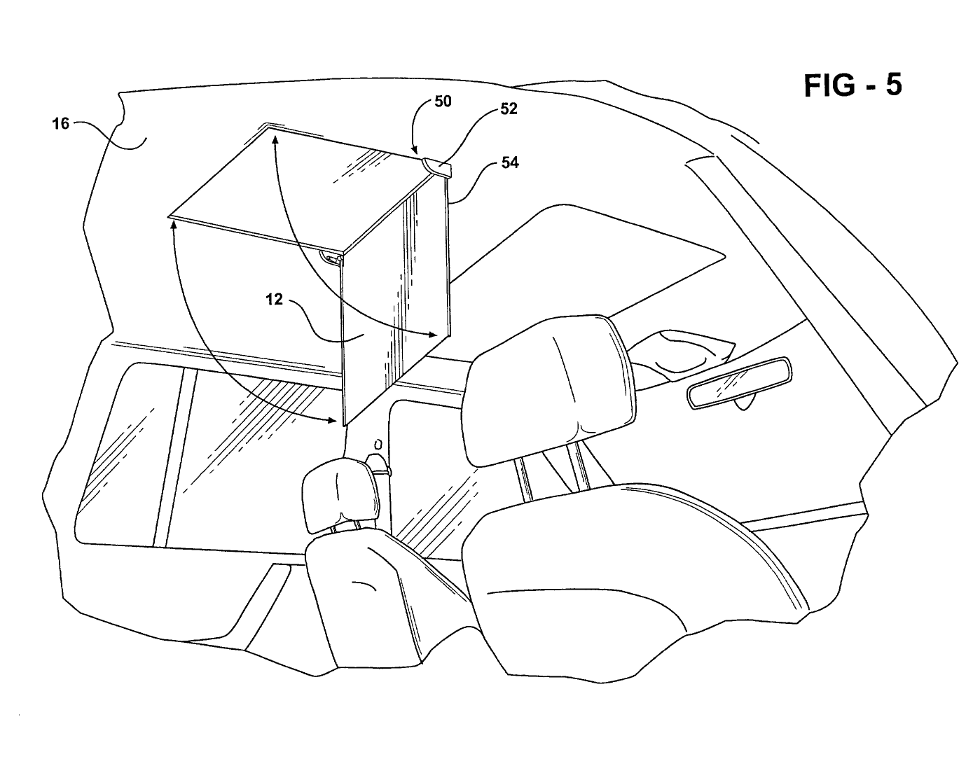

Referring now to FIG. 5, another installation arrangement of the screen 12 on the headliner's exterior may comprise a framed, pivotable hinge structure 50. The pivoting action of the screen 12 may occur by using a pair of snap-action hinges 52 that may be manually actuated when deploying the screen 12 to and from a stowed position. The structure 50 may include at least two support rods 54, which may be transparent to provide the driver with a less obstructed rear view, which also provides a sturdy frame for the screen 12. If desired, the installation arrangement may include the screen stabilizing system 38, such as the tethers 40 with hooks 42 described above.

Referring now to FIG. 6, an installation arrangement of the screen 12 may be modularly incorporated into the interior structure of the headliner 16. The screen 12 may be manually deployable from a cylindrical pull-pull dispensing device 55 by a deployment bar 44, tab 56, hook 58, or the like, by a downward force, F. If desired, the screen stabilizing system 38 including the tethers 40 and transparent plastic rods 48 may be used either singularly, or in combination with each other in this particular embodiment.

Although each of the installation arrangements of the screen 12 discussed above in FIGS. 2-6 disclose manually deployed embodiments, the screen 12 may be deployed by other means including hydraulic deployment, pneumatic deployment, electrical deployment 60, or the like. Referring to FIG. 7, electrical deployment 60, for example, may be actuated with similar circuitry used to operate a power window, such as an actuating mechanism including a power source 62 and a motor 64, coupled to an input switch 66 and a polarity switch 68.

Referring now to FIGS. 8A and 8B, the projector 14 of the PES 10 may be located in a mini-van 11. According to FIG. 8A, the projector 14 may be located in an interior trim component, for example, the headliner 16. Similar to the embodiments of the screen 12 discussed above, the projector 14 may be either located on the exterior of the headliner 16, or alternatively on other interior trim components including B-pillars, or the like. The projector 14 may also be modularly incorporated into the interior structure of the headliner 16, or alternatively on other interior trim components including B-pillars, or the like.

In this particular embodiment discussed above for FIG. 8A, the projector 14 may be deployed either manually, hydraulically, pneumatically, electrically, or the like, as discussed above in similar fashion to the screen 12. It is also desirable to direct light, 15, of the image from the projector 14 at an angle into the screen 12 that permits the light, 15, to pass through the micro-perforations and onto the floor of the vehicle behind the driver's sight-line so that the driver is not distracted by the image.

According to FIGS. 8B-9B, the projector 14 may alternatively be located about the base pan area 18 of the vehicle. As seen in greater detail in FIGS. 9A and 9B, according to one embodiment of the invention, the projector 14 may be located in a structural storage bin 20 over the carpeted base pan 70 and adjacent to the rear sill and trim plate area 72. By stowing the projector 14 in the structural bin 20, design alterations of the base pan 18 may be kept to a minimum for accommodating the projector 14. As seen more clearly in FIG. 9B, the structural bin 20 includes a door panel 74 for protecting and hiding the projector 14 from the view of passengers in the vehicle. The projector 14 is also shown to be desirably stored at the rear most portion of the mini-van 11 so that the viewing area of the screen 12 may be maximized on an inclined angle. Although not shown, the projector 14 may be located within the interior structure of the base pan 18 and be deployed either manually, hydraulically, pneumatically, electrically, or the like, as discussed above in similar fashion to the screen 12.

Referring now to FIGS. 10 and 11A-11B, the projector 14 of the PES 10 may be located in a sedan 13; however, it is also contemplated that the following embodiment could also be equally applied to a non-sedan vehicle such as minivan 11, van, sport-utility vehicle (SUV), or the like. In this embodiment, the projector 14 may be located in the rear seat structure, such as in the armrest 22. Referring to FIG. 11A, the armrest 22 is shown in a stowed position and hides the projector 14 from view of the passengers. Once the armrest 22 is deployed (FIG. 11B), the projector 14 may pivot to an inclined angle at the rear portion of the armrest 22.

Alternatively, the projector 14 may be located in the trunk area. If the deployment of the armrest 22 is designed as a ‘ski passage’ 24 for transporting items that have a length greater than the depth of the trunk, the projector 14 may be able to project an image from the trunk through the ski passage 24. Yet even further, the rear seat 26 may further comprise an opening 24, which is similar to the ski passage, that may allow the projector 14 located in the trunk to transmit the image to the screen 12 located on the headliner 16. If a DVD player/changer is located in the trunk area, the projector 14 may directly be attached to the DVD player/changer.

In the embodiments discussed above for FIGS. 8B-11B (i.e. when the projector 14 is located about the base pan 18 or rear seat area 26 for either a mini-van 11 or sedan 13), it is desirable to direct the projected light, 15, into the screen 12 at an angle that permits light, 15, to pass through the micro-perforations and into the headliner 16 behind the driver's head. It is also desirable to project the light, 15, at an angle divergent from the rear-view mirror viewing angle of the driver's sight-line. It is also desirable to locate the projector 14 as far back as possible in the rear portion of the vehicle in order to maximize the viewing area of the screen 12, thereby resulting in a ‘big screen’ effect.

Thus, the inventive projection entertainment system (PES) 10 described above provides the feature of a ‘big screen’ effect for passengers seated in the rear portion of a vehicle by increasing the viewing area of the screen 12 while not entirely obstructing the view of the driver. The inventive PES 10 may be installed on the assembly line or be modularly installed in the vehicle interior trim prior to when the vehicle is assembled on the assembly line in order to limit after market installation damage to the vehicle interior.

Although certain preferred embodiments of the present invention have been described, the invention is not limited to the illustrations described and shown herein, which are deemed to be merely illustrative of the best modes of carrying out the invention. A person of ordinary skill in the art will realize that certain modifications and variations will come within the teachings of this invention and that such variations and modifications are within its spirit and the scope as defined by the claims.

1. A vehicular entertainment system, comprising:
a projector for projecting an image in a vehicle; and
a semi-transparent screen deployable from an interior trim component of said vehicle for receiving the projected image in the vehicle.

2. The vehicle entertainment system of claim 1, wherein the interior trim component is a headliner.

3. The vehicle entertainment system of claim 2, wherein the projector is deployable from the base pan and further comprises a screen stabilizing system for stabilizing the semi-transparent screen.

4. The vehicle entertainment system of claim 1, wherein the interior trim component is a B-pillar.

5. The vehicle entertainment system of claim 1, wherein the interior trim component is a rear portion of a front seat.

6. The vehicular entertainment system of claim 1, wherein the semi-transparent screen and the projector are manually deployable.

7. The vehicular entertainment system of claim 1, wherein the semi-transparent screen and the projector are electrically deployable.

8. The vehicular entertainment system of claim 1, wherein the projector is located about an exterior surface of the interior trim component.

9. The vehicular entertainment system of claim 1, wherein the projector is located in an interior compartment of the interior trim component.

10. The vehicular entertainment system of claim 1, wherein the projector is located about an exterior surface of a base pan of the vehicle.

11. The vehicular entertainment system of claim 1, wherein the projector is located in an interior compartment of a base pan of the vehicle.

12. The vehicular entertainment system of claim 1, wherein the projector is located in a structural bin having a lid, wherein the structural bin is placed about a base pan of the vehicle.

13. The vehicular entertainment system of claim 1, wherein the projector is located about a pivotable armrest of a rear seat.

14. The vehicular entertainment system of claim 1, wherein the projector is located in a trunk portion of the vehicle.

15. The vehicular entertainment system of claim 14, wherein the projector projects an image through an opening in a structural member of a rear portion of the vehicle.

16. The vehicular entertainment system of claim 1, wherein the semi-transparent screen is incorporated into an interior compartment of the interior trim component, wherein the semi-transparent screen is deployable from the interior compartment by a cylindrical pull-pull dispensing device.

17. The vehicular entertainment system of claim 1, wherein the semi-transparent screen is deployable from a storage tube onto which the semi-transparent screen is attached and rolled for storage.

18. The vehicular entertainment system of claim 17, wherein the storage tube is secured to an exterior surface of the interior trim component by a pair of spring-loaded clips.

19. The vehicular entertainment system of claim 1, wherein the semi-transparent screen is defined by a viewing surface having a length and a width, and further comprises a deployment bar and a tab located along the length of the semi-transparent screen.

20. The vehicular entertainment system of claim 1, further comprising a screen stabilizing system coupled to the semi-transparent screen for stabilizing the semi-transparent screen.

21. The vehicular entertainment system of claim 20, wherein the screen stabilizing system comprises at least one tether and one locating hook.

22. The vehicular entertainment system of claim 20, wherein the screen stabilizing system comprises at least a pair of plastic rods.

23. The vehicular entertainment system of claim 1, wherein the semi-transparent screen includes a framed, pivotable hinge structure including at least two support bars.

24. A vehicular entertainment system installed in a vehicle, wherein the vehicle includes a headliner, comprising:
a projector for projecting an image that is deployable from the headliner;
a semi-transparent screen defined by a viewing surface having a length and a width, wherein the semi-transparent screen is deployable from the headliner and adapted to-receive the projected image and
a screen stabilizing system coupled to the semi-transparent screen for stabilizing the semi-transparent screen.

25. The vehicular entertainment system of claim 24, wherein the semi-transparent screen further comprises a deployment bar and a tab located along the length of the semi-transparent screen.

26. The vehicular entertainment system of claim 24, wherein the semi-transparent screen is deployable from a storage tube onto which the semi-transparent screen is attached and rolled for storage.

27. The vehicular entertainment system of claim 26, wherein the storage tube is secured to an exterior surface of the headliner by a pair of spring-loaded clips.

28. The vehicular entertainment system of claim 24, wherein the screen stabilizing system comprises at least one tether and one locating hook.

29. The vehicular entertainment system of claim 24, wherein the screen stabilizing system comprises at least a pair of transparent plastic rods.

30. The vehicular entertainment system of claim 24, wherein the semi-transparent screen includes a framed, pivotable hinge structure including at least two transparent bars.

31. The vehicular entertainment system of claim 24, wherein the semi-transparent screen is incorporated into an interior compartment of the headliner, wherein the semi-transparent screen is deployable from the headliner by a cylindrical pull-pull dispensing device.

32. The vehicular entertainment system of claim 24, wherein the semi-transparent screen and the projector are electrically deployable.

33. A vehicular entertainment system, wherein the vehicle includes a headliner, a trunk, and a rear seat including a pivotable armrest, comprising:
a projector that is operable when the armrest is pivotably deployed;
a semi-transparent screen defined by a viewing surface having a length and a width, wherein the semi-transparent screen is deployable from the headliner and is adapted to receive an image projected from the projector; and
a screen stabilizing system for stabilizing the semi-transparent screen.

34. The vehicular entertainment system of claim 33, wherein the projector is located about the pivotable armrest.

35. The vehicular entertainment system of claim 33, wherein the projector is located in a trunk portion of the vehicle.
